(19) United States
(12) Patent Application Publication
(10) Pub. No.: US 2003/0205430 A1
(43) Pub. Date: Nov. 6, 2003

(54) Fire escape device

(76) Inventor: Jae-Hum Na, Daegu (KR)

Correspondence Address: Paul J. Farrell, DILWORTH & BARRESE, LLP, 333 Earle Ovington Blvd., Uniondale, NY, 11553, US

(21) Appl. No.: 10/186,870

(22) Filed: Jul. 1, 2002

(30) Foreign Application Priority Data
May 6, 2002 (KR) 2002/0013852

(51) Int. Cl. A62B 1/06

(52) U.S. Cl. 182/72; 182/71

(57) ABSTRACT

An escape device including a woven fabric shaped rope installed in the inner space of a housing board, a braking member including a resistant frame, a handle, and a plurality of resistant rods spaced apart by compressing springs between the rods, the braking member provided to reduce the lowering speed of the device and a harness consisting of a waist belt and a bottom belt is provided. The device is used for safely lowering a person from high altitudes, such as a hotel, apartment, hospital or commercial building, onto the ground. The outside surface of the housing board may be configured to install a painting, picture or clock so that the housing board can be used as a displaying flame when the device is hung on the wall of room. The housing may be in the shape of any type of animal or cartoon character so that a user is familiar with it. The woven fabric rope defines one rope and is released by pulling one end of the rope. The releasing rope from the woven fabric passes through the resistant rods and the handle in the shape of a zig-zag for creating maximum resistance between the rope and the resistant rods. When a user pushes down the handle, the lowering speed decreases because the gaps among the rods are narrow and the resistance between the rope and the resistant rods increases. The lowering speed increases when the user lifts the handle because the gaps among the rods are widen and the resistance decreases. The rods are positioned under the handle, vertically parallel each other, and perpendicular to the rope.

### BACKGROUND OF THE INVENTION

1. Technical Field

The present invention relates to an escape device for lowering a person from high altitudes, e.g., a hotel, apartment, hospital, commercial building or other high-rise buildings, onto the ground, and more particularly to an escape device utilizing a woven fabric shaped rope installed in an inner space of a housing board to be worn by a user.

2. Background of the Related Art

With an increase in multistoried buildings, apparatuses for meeting emergency situations are very common and indispensable instruments. Especially, fire escape devices are essential in certain areas where it is difficult or impossible for a helicopter or an elevated ladder to reach the high altitudes. Various types of escape devices have been proposed.

For example, U.S. Pat. No. 2,729,425 to Gschwind is directed to a safety device which comprises a housing, a safety cable pulley member rotatably carried within said housing, a safety cable having one end connected to said pulley member, said housing having an aperture formed in one wall thereof and through which the opposite free end of said cable projects for connection to a point distant from said housing, braking means carried by said pulley member and movable into engagement with said pulley member for preventing rotation of said pulley member in one direction, means for normally holding said braking means from braking position with respect to said pulley member, and means carried by said pulley member for releasing said holding means to permit said braking means to move in the direction of rotation of said pulley member to prevent rotation of said pulley member in said one direction when the rotation of said pulley member reaches a predetermined speed.

U.S. Pat. No. 4,114,726 to Sentinella is directed to a fire escape device which comprises a pair of arms pivotally connected together at respective ends for movement between an open position and a closed position and which is used in a fire escape apparatus including also a length of cable and a harness. The distal ends of the arms can be fastened together when the arms are in the closed position. The arms are provided with respective means each defining at least a part of a passage and when the arms are in the closed position the respective means cooperate to thereby define a tortuous passageway between the arms for a rope or a cable.

U.S. Pat. No. 4,301,892 to Arce is directed to a fire emergency descent device utilizing straps securable onto a persons back, and a spool-mounted line controllably releasable through overhead wire guide supports adjustable to alter the hanging position of the strapped-in person, and rate of descent being controllable either manually by a manually-adjustable variable valve and a second valve normally preset to correspond to a person's weight to controllably regulate release of compressed air from a piston cylinder housing in which air becomes compressed by piston action resulting from spinning of the spool during descent.

U.S. Pat. No. 4,191,275 to Mansfield, Jr. is directed to a safety harness kit, particularly for use in escape from a burning building, including a harness, rope, a channel bar, and a hook. The harness is adaptable for use by adults and children and is made from stiff belting material.

Even though these devices may be suitable for the specific individual purposes for which they are designed, they differ from the present invention in that the present invention provides several unique features and advantages as hereinafter contrasted.

### SUMMARY OF THE INVENTION

An object of the present invention is to provide a novel type of escape device for safely lowering a person from high heights onto the ground, which has a simple configuration, is convenient and safe to use or hold, and is economical to manufacture.

In accordance with the present disclosure, an escape device including a woven fabric shaped rope consisting of one rope which is continuously released by pulling one end of the rope and which is installed in the inner space of a housing board, a braking member including a resistant frame, a handle, and three resistant rods comprising compressing springs among the rods, the braking member installed in the inner space of the housing board, and a harness consisting of a waist belt and a bottom belt is provided. The housing board is configured to define an inner space so that a woven fabric and the braking member may be installed. The outside surface of the housing board may be configured to install a painting, picture or clock so that the housing board is used as a displaying frame when the device is hung on the wall of room when not in use. The rope from the woven fabric passes through the resistant rods and the handle in a zig-zag pattern for creating maximum resistance between the rope and the braking member. When a user pushes down the handle, the lowering speed decreases because the gaps among the three rods are narrow and the resistance between the rope and the braking member increases. When the pressure on the handle is released, the lowering speed increases because the gaps among the rods widen and the resistance decreases, when the user lifts up the handle. The rods are preferably positioned under the handle, vertically parallel to each other, and generally perpendicular to the rope.

### BRIEF DESCRIPTION OF THE DRAWINGS

The above objects and other advantages of the present invention will become more apparent from the following detailed description taken in conjunction with the accompanying drawings, in which:

FIG. 1 illustrates a perspective view of an escape device in accordance with a preferred embodiment of the present invention;

FIG. 2 illustrates a side sectional view showing an inner portion of a housing board, a woven fabric shaped rope, a braking member, and a hook of FIG. 1;

FIG. 3 illustrates a front sectional view showing an inner portion of a housing board, a woven fabric shaped rope, a braking member, and a hook of FIG. 1;

FIG. 4 illustrates an enlarged plan view showing the braking member in accordance with the present invention;

FIG. 5 illustrates an enlarged side view showing the braking member in accordance with the present invention;

FIG. 6 illustrates an exploded perspective view showing the braking member in accordance with the present invention;

FIG. 7 illustrates a plan view showing a preferred configuration of a woven fabric shaped rope in accordance with the present invention; and

FIG. 8 illustrates a diagrammatic view showing a person lowering himself from a high altitude to the ground while using the device of the present invention.

### DETAILED DESCRIPTION OF PREFERRED EMBODIMENTS

Preferred embodiments of the presently disclosed escape device will now be described in detail with reference to the drawings in which like reference numerals designate identical or similar elements in each of the several views.

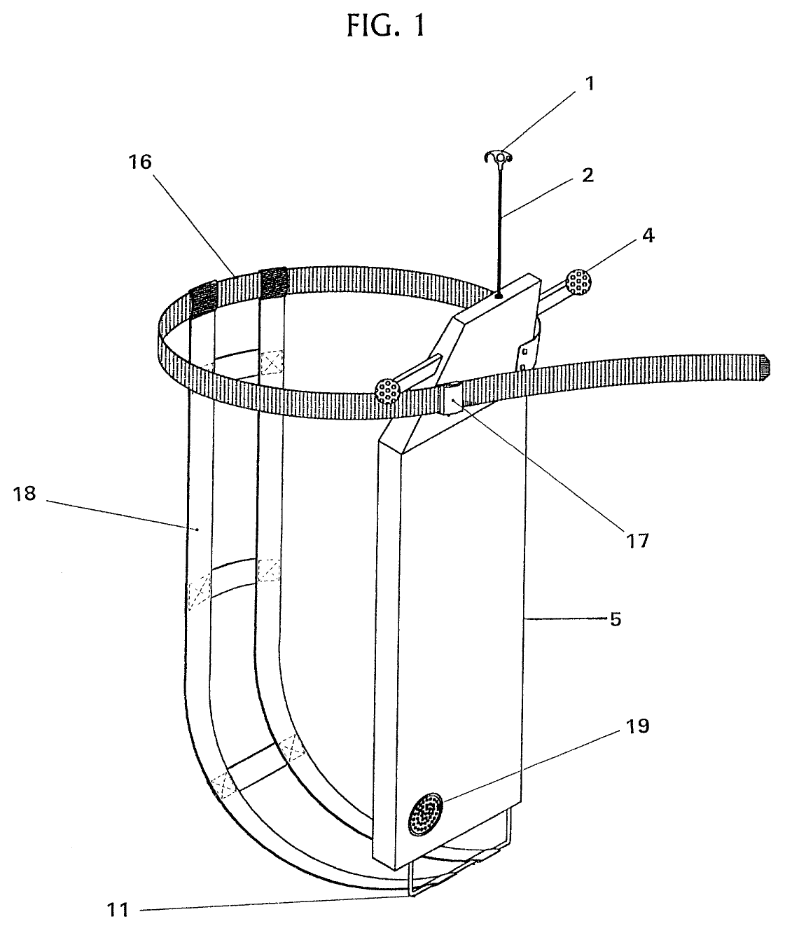

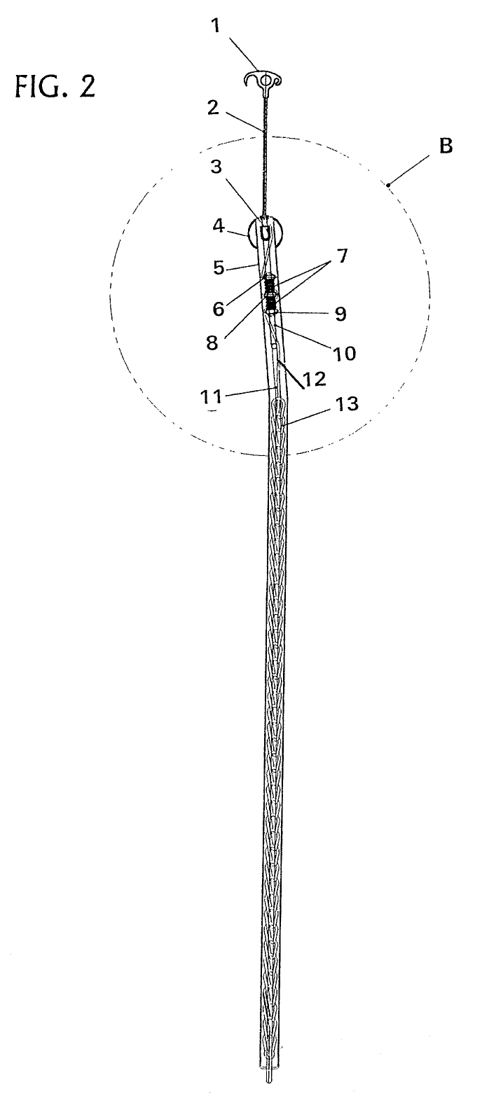

Referring to FIGS. 1-3 and 7, an escape device comprises a housing board 5 having an inner space, a harness consisting of a waist belt 16 and a bottom belt 18, a woven fabric shaped rope 13 installed in the inner space of a housing board 5, and a braking member having a resistant frame 10, a handle 3, and three resistant rods 6, 8, and 9 connected by compressing springs 7 for controlling the lowering speed of the device. A speaker 19 may be provided in the housing board 5 to inform a user on how to use the device. The speaker 19 is connected to circuitry having a voice message stored in a memory. Upon activation of the circuitry, the message signal is passed to a voice synthesizer which outputs the voice message to a user through the speaker. The message is perferably a set of instructions for the use, but can be any message. The waist belt 16 includes a buckle 17 to be fastened. The housing board 5 is preferably a flat board including an inner space in which the woven fabric rope 13 and the braking member are vertically installed. The handle 3 and three resistant rods consisting of a first rod 9, a second rod 8 and a third rod 6 are positioned vertically parallel to each other and generally perpendicular to a rope end 12. The outside surface of the housing board 5 is configured to have a means to install a painting, picture or clock so that the housing board 5 may be used as a displaying frame when the device is hung on the wall of room when not in use. The shape of housing board 5 is configured to accommodate any type of animal or cartoon character to which a user is familiar on the outer surface of the board, to decorate the wall of facilities where the device is stored. The housing board 5 preferably has a connecting bar 11 to be connected with the bottom belt 18.

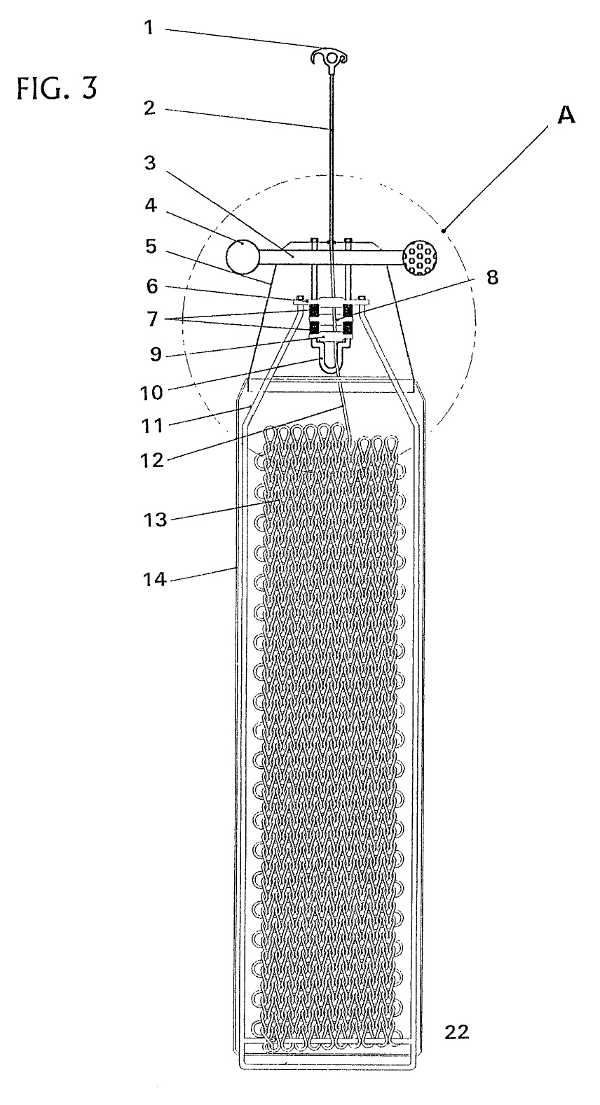

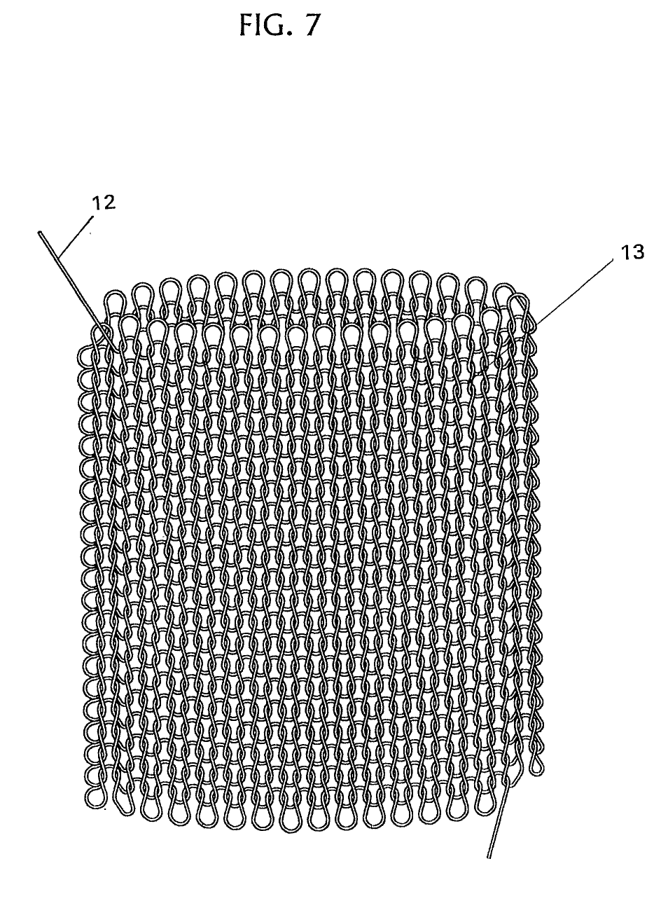

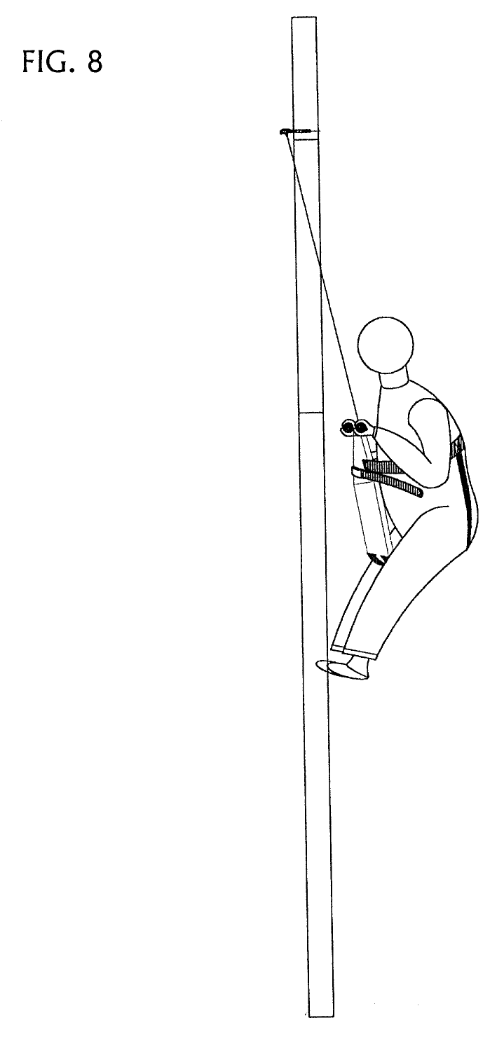

The woven fabric shaped rope 13 consists of one rope. The configuration and shape of fabric shape rope 13 can vary as long as the rope 13 is woven, to be able to be released by pulling one end of the rope 13 as shown in FIGS. 3 and 8. The upper end 12 of the rope 13 is connected to a hook 1 while the other end is connected to the bottom portion of the housing board 5. Preferably a bottom bar 22 installed in the inner space of the housing board 5 may be provided to be connected to the other end of the rope 13. When the hook 1 is pulled by weight of user, the rope 13 can be continuously released at a certain speed rate. The woven fabric shaped rope 13 is preferably coated by paraffin wax to increase resistance during releasing and reduces the lowering speed of the device. The strength of the resistance of the paraffin coated fabric rope 13 depends on the thickness of the paraffin. This is the first braking step of the device. The strength of the resistance while releasing the fabric rope 13 must be weaker than that of weight of the user so that the device moves down. The coated paraffin also prevents the rope 13 from getting tangled. The shape and configuration of the fabric weave can vary, such as that normally used for a towel (as shown in FIG. 3), a sock, or an envelop (as shown in FIG. 7). The upper end 12 of the rope 13 connected to the hook 1 can be covered with wire netting 2 to prevent the rope from breaking in the event it contacts a sharp foreign object.

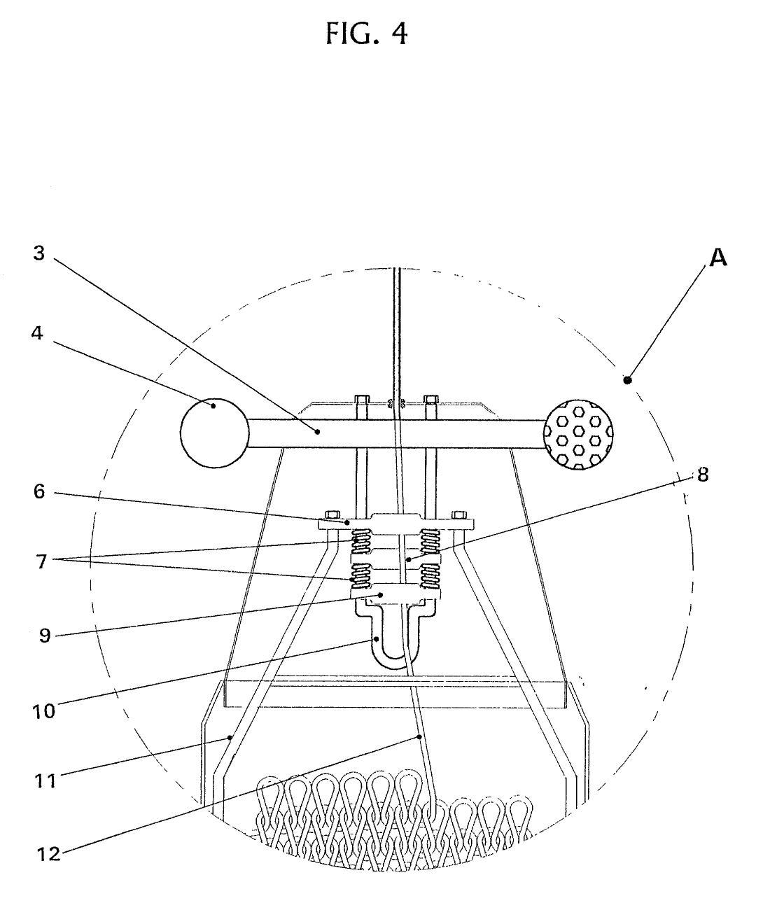

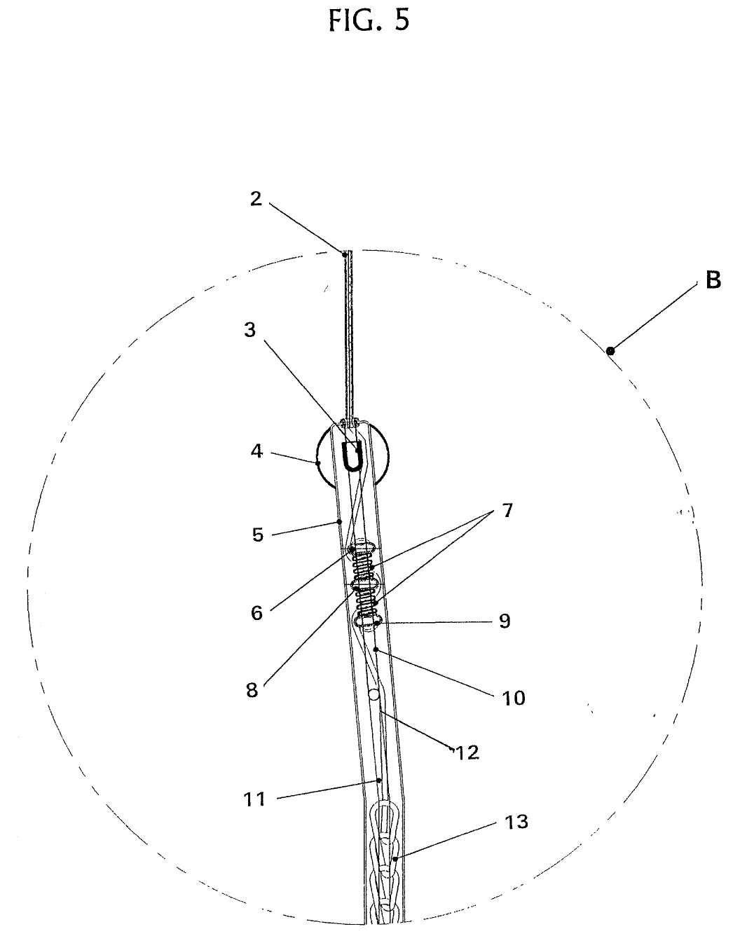

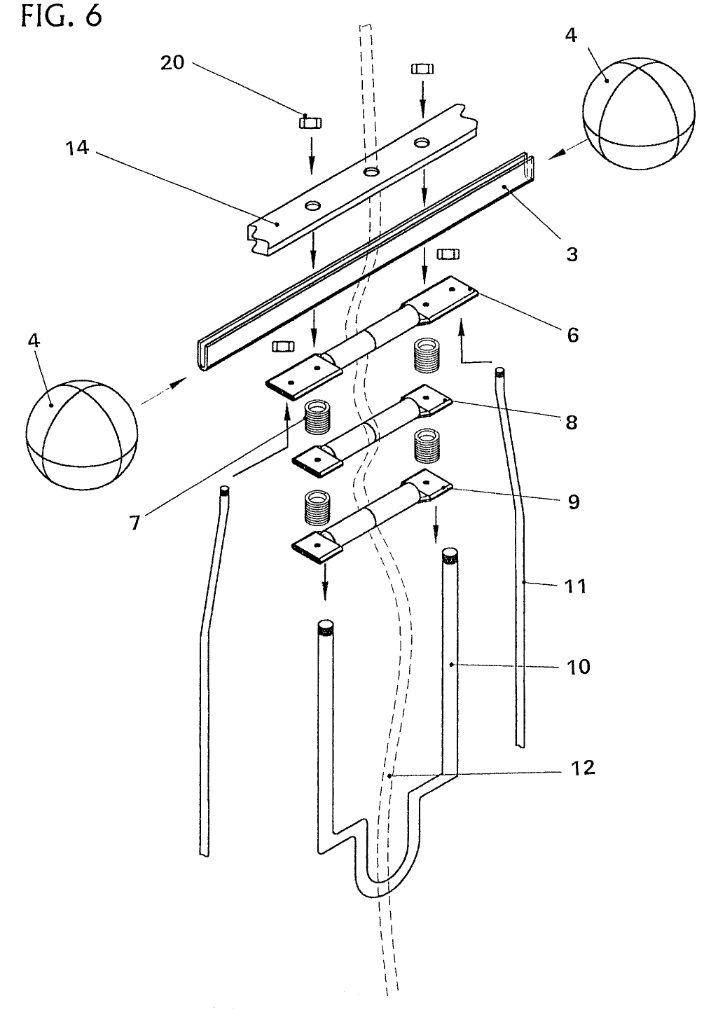

Referring to FIGS. 4-6, a braking member having a resistant frame 10, a handle 3, and three resistant rods 6, 8, and 9 separated and connected by compressing springs 7 is provided with the device to further control the lowering speed of the device. The handle 3 and three resistant rods consisting of a first rod 9, a second rod 8 and a third rod 6 are vertically parallel positioned and connected to the resistant frame 10. Compressing springs 7 are installed among the three rods 6, 8, and 9 for keeping the spacing and tension among the rods. The third rod 6 is also connected to a weight frame 11 so that the weight of user is transferred on the three rods 6, 8 and 9 with compressing springs 7. When a person uses the device and the weight of user is on the three rods 6, 8 and 9, the gaps between them become narrow, and the resistance between the releasing rope 12 and the rods 6, 8, and 9 increases to reduce the lowering speed. This is the second braking step of the device. The lowering speed is preferably be around 1.2 meters per second regardless of the weight of user because the heavier the user, the more resistance the rods creates. When a user wishes to adjust the lowering speed, the user uses the handle 3. The lowering speed decreases when a user pushes down the handle 3 to make the gaps of the rods 6, 8 and 9 narrow so that the resistance between the releasing rope 12 and the rods 6, 8 and 9 increases. This is the third braking step of the device. The releasing rope 12 passes between the rods 6, 8 and 9 to create the resistance in the shape of zig-zag. The handle 3 has ball shaped ends 4 portions to be convenient to grasp.

Referring to FIG. 8, a user hangs the hook 1 of the device on a fixture in the room and wears the device with the user facing the inner aspect of the housing board 5 when the bottom belt 18 is positioned between the legs of the user, and the waist belt 16 fastens the user to the housing board 5. The user lowers himself out of the room at a high attitude while grasping the handle 3. In this case, the user moves down at a certain lowering speed because of the resistance from the fabric paraffin and three rods 6, 8 and 9 touching the releasing rope 12. The user can further control the lowering speed because the lowering speed decreases when a user pushes down on the handle to make the gaps between the rods and the handle narrow so that the resistant increases.

It will be understood that various modifications may be made to the embodiments disclosed herein. Therefore, the above description should not be construed as limiting, but merely as exemplifications within the scope and spirit of the claims appended hereto.

What is claimed is:

1. An escape device comprising:
a woven fabric shaped rope consisting of one rope which is continuously released by pulling one end of the rope.

2. An escape device according to claim 1, wherein the woven fabric shaped rope is coated by paraffin.

3. An escape device comprising:
a housing board having an inner space;
a woven fabric shape rope consisting of one rope which is continuously released by pulling one end of the rope; and
a braking member including at least two rods, the braking member installed in the inner space of the housing board and provided to reduce the lowering speed of the device due to resistance between the rope and the braking member when the rope passes through the rods in the shape of zig-zag.

4. An escape device according to claim 3, wherein an outside surface of the housing board is configured for installing one of a painting, a picture, and a clock.

5. An escape device according to claim 3, wherein the housing board is in the shape of an animal or cartoon character.

6. An escape device according to claim 3, wherein the woven fabric shaped rope is coated by paraffin.

7. An escape device according to claim 3, further comprising a hook connected to one end of the rope.

8. An escape device according to claim 7, wherein an end portion of the rope is covered with a metallic web.

9. An escape device according to claim 3, further comprising a harness including a waist belt and a bottom belt connected to the housing board.

10. An escape device according to claim 1, further comprising a speaker to inform a user on how to use the device.

11. An escape device according to claim 3, wherein the braking member includes a resistant frame, a handle, and three resistant rods comprising compressing springs among the rods

12. A escape device comprising:
a housing board having an inner space;
a woven fabric shaped rope consisting of one rope which is continuously released by pulling one end of the rope and which is installed in the inner space of housing board;
a braking member including a frame, a handle, and a plurality of resistant rods spaced apart by compressing springs between the rods, the braking member installed in the inner space of the housing board and provided to reduce the lowering speed of the device due to resistance between the rope and the braking member when the rope passes through the rods in the shape of zig-zag;
a hook connected to the one end of the rope; and
a harness connected to the housing board to secure the escape device on a user's body.

13. A method of escaping a high-rise building, utilizing an escape device having a woven fabric shaped rope consisting of one rope which is continuously released by pulling one end of the rope, and a braking member including a handle and a plurality of resistant rods spaced apart by compressing springs between the rods, the braking member reducing a lowering speed of the device due to resistance between the rope and the braking member, a hook connected to the one end of the rope, and a harness for wearing the escape device, the method comprising steps of;
securing the hook to a fixture;
wearing the device on a user's body;
the user lowering himself our of the high-rise building;
unravelling the woven fabric shaped rope to extend the rope and to lower the user;
controlling the lowering speed of the device by adjusting the spacing between the rods to a plurality of increase and/or decrease resistance between the rope and rods, upon pushing and/or pulling on the handle.
